(19) United States
(12) Patent Application Publication
(10) Pub. No.: US 2008/0060681 A1
(43) Pub. Date: Mar. 13, 2008

(54) Apparatus and method for treating substrate

(75) Inventors: Young-Ho Choo, Cheonan-shi (KR); Hye-Sun Jung, Yongin-shi (KR)

Correspondence Address: HARNESS, DICKEY & PIERCE, P.L.C., P.O. BOX 8910, RESTON, VA, 20195, US

(73) Assignee: Semes Co., Ltd.

(21) Appl. No.: 11/896,350

(22) Filed: Aug. 31, 2007

(30) Foreign Application Priority Data
Sep. 12, 2006 (KR) 10-2006-0087940

(51) Int. Cl. B08B 3/10

(52) U.S. Cl. 134/26; 134/105; 134/35

(57) ABSTRACT

A substrate treating apparatus includes a treating unit including a treating bath which a treating solution is supplied into and stored in and treating solution supply means for supplying the treating solution into the treating bath; and a drying unit including a drying bath into which fluid is supplied and injected and fluid supply means for supplying the fluid into the drying bath, wherein the fluid supply means includes a filter configured to filter the fluid before the fluid is supplied into the drying bath and a first heater configured to heat the filter. According to the substrate treating apparatus, the generation of particles caused by supplying solidified drying fluid into a drying bath is suppressed to treat a substrate without error. As a result, a production or yield increases.

### CROSS-REFERENCE TO RELATED APPLICATIONS

This U.S. non-provisional patent application claims priority under 35 U.S.C § 119 of Korean Patent Application 2006-87940 filed on Sep. 12, 2006, the entirety of which is hereby incorporated by reference.

### BACKGROUND

The present invention relates to a substrate treating apparatus and a substrate treating method. More specifically, the present invention is directed to a substrate treating apparatus including a treating bath and a drying bath disposed up and down and a substrate treating method using the apparatus.

In manufacturing of semiconductor devices, cleaning apparatuses have been used to remove particles such as organic contaminants and metallic impurities attached to the surface of a target object (hereinafter referred to as “substrate”) such as a semiconductor wafer or an LCD organic substrate. Among the cleaning apparatuses, wet cleaning apparatuses are increasingly being used due to their efficient removal of particles and their higher throughput. A conventional wet cleaning apparatus is configured to perform a chemical treatment, a water cleaning treatment, and a drying treatment. However, the individual installation of a treating bath and a drying bath causes an apparatus to increase in size and results in the possibility that particles are attached to a wafer which is exposed to the air to be transferred.

Accordingly, many attempts have been made to prevent an apparatus from increasing in size and efficiently perform treatments for a substrate. An improved example of a substrate treating apparatus is disclosed in Korean Patent Publication No. 1998-25068. The improved substrate treating apparatus includes a treating bath and a drying bath that are monolithically disposed up and down. A wafer is dried in the drying bath after being chemically treated in the treating bath.

Conventionally, an improved substrate treating apparatus uses isopropyl alcohol (IPA) as drying fluid. Before flowing into a drying bath, IPA may be solidified. The solidified IPA may be injected and attached to a substrate to act as particles.

### SUMMARY OF THE INVENTION

Exemplary embodiments of the present invention provide a substrate treating apparatus. In an exemplary embodiment, the substrate treating apparatus may include: a treating unit including a treating bath and a treating solution supply means for supplying the treating solution into the treating bath; and a drying unit including a drying bath and a fluid supply means for supplying the fluid into the drying bath, wherein the fluid supply means includes a filter configured to filter the fluid before the fluid is supplied into the drying bath and a first heater configured to heat the filter.

In another exemplary embodiment, the substrate treating apparatus may include: a treating bath; a treating solution injection nozzle installed inside the treating bath and configured to inject a treating solution into the treating bath; a drying bath disposed on the outside top of the treating bath and having open top and bottom, wherein a sliding door is provided between the open bottom and the treating bath, and a lid is provided to the open top; a substrate support configured to support the substrate and transfer the substrate between the treating bath and the drying bath; a gas injection nozzle disposed inside the drying bath and configured to inject gas used to dry the substrate into the drying bath; a filter disposed outside the drying bath and configured to filter the gas; and a heater jacket installed to surround the filter and configured to heat the filter.

Exemplary embodiments of the present invention provide a substrate treating method. In an exemplary embodiment, the substrate treating method may include: putting a substrate into a drying bath; transferring the substrate to a treating bath from the drying bath; supplying a treating solution into the treating bath to treat the substrate; transferring the treated substrate to the drying bath; supplying fluid into the drying bath to dry the substrate, wherein before supplying the fluid into the drying bath, the fluid is heated to prevent the solidification of the fluid; and drawing out the dried substrate.

In another exemplary embodiment, the substrate treating method may include: putting a substrate into a drying bath; filtering first fluid through a filter and supplying the filtered first fluid into the drying bath to primarily dry the substrate; filtering second fluid through a filter and supplying the filtered second fluid into the drying bath to secondarily dry the substrate; and heating the filter to prevent at least one of the first and second fluids from being solidified at the filter.

### BRIEF DESCRIPTION OF THE DRAWINGS

FIG. 1 is a configuration diagram of a substrate treating apparatus according to the present invention.

FIG. 2 is a perspective view of a part of the substrate treating apparatus illustrated in FIG. 1.

FIG. 3 is a partial enlarged view of FIG. 2.

FIG. 4 is a flowchart illustrating a substrate treating method according to the present invention.

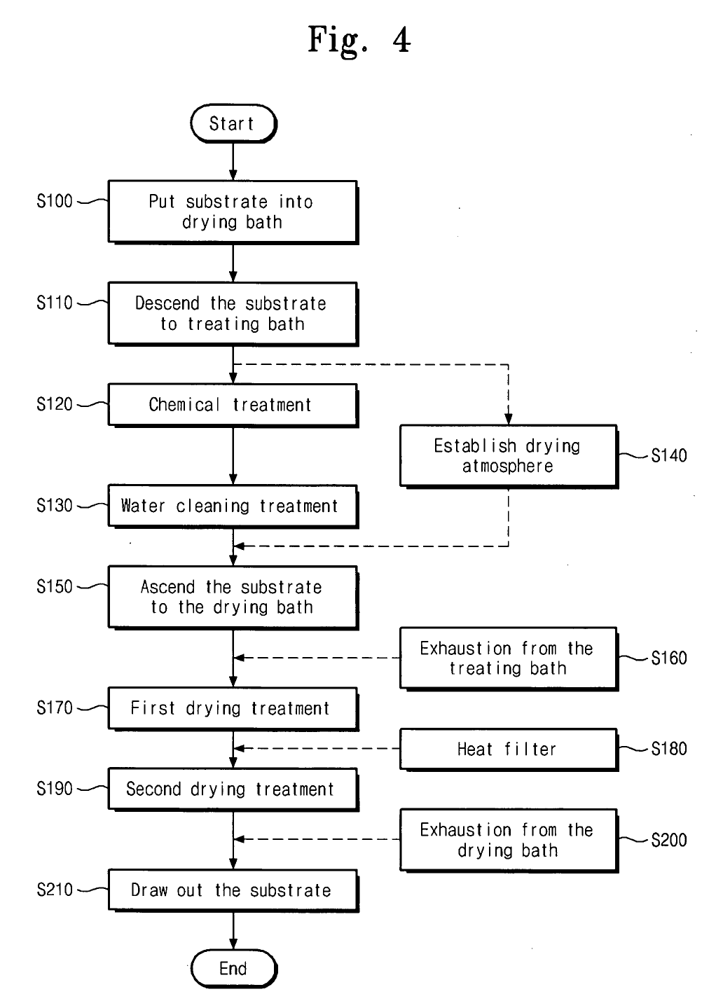

### DETAILED DESCRIPTION OF PREFERRED EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

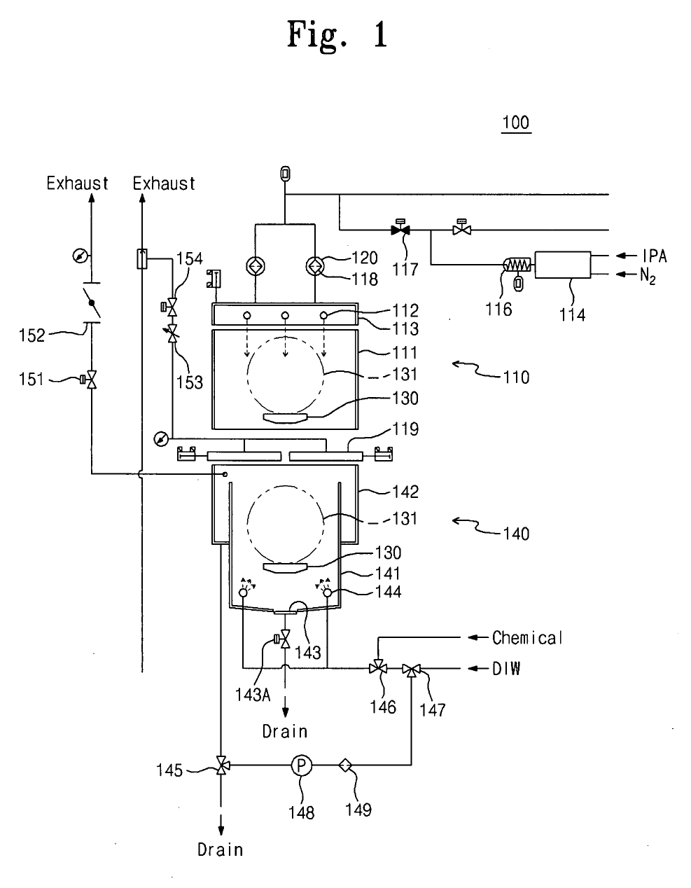

A substrate treating apparatus 100 according to the present invention is illustrated in FIG. 1. Referring to FIG. 1, the substrate treating apparatus 100 includes a treating unit 140 configured to perform a wet treatment for a substrate 131 using a treating solution and a drying unit 110 disposed on the outside top of the treating unit 140 to dry the wet-treated substrate 131 using a drying fluid. In this embodiment, the substrate 131 may be any one of a semiconductor wafer, an LCD substrate, a glass substrate, and so forth.

The treating unit 140 includes a treating bath 141 receiving a plurality of substrates 131 supported by a substrate support 130 while standing upright. Nozzles 144 are disposed at opposite lower sides of the treating bath 141 to supply a treating solution into the treating bath 141. Depending on whether valves 146 and 147 are opened or closed, a mixed solution or deionized water (DIW) is supplied to the nozzle 144. The mixed solution includes a chemical such as, for example, HF, HCl or NH₄.

A recovery bath 142 is disposed outside the treating bath 141 to recover the treating solution overflowing from the treating bath 141. The treating solution recovered to the recovery bath 142 is circulated by means of valves 145 and 147, a pump 148, and a filter 149 before being re-supplied to the nozzle 144. Depending on whether a valve 145 is opened or closed, the treating solution recovered to the recovery bath 142 is circulated or drained. A drain hole 143 is formed at the lowermost portion of the treating bath 141. When a valve 143A is opened, the treating solution supplied to the treating bath 141 is drained to the outside of the treating bath 141 through the drain hole 143. Due to a chemical, the treating bath 141 may be filled with noxious gases or fumes or drying fluid may be supplied to the treating bath 141 from the drying bath 111. Thus, noxious gases or fumes or drying fluid in the treating bath 141 may be exhausted by means of a valve 151 and a damper 152.

The drying unit 110 includes a drying bath 111 receiving a plurality of substrates 131 supported by a substrate support 130. The substrate support 130 is ascended or descended between the treating bath 141 and the drying bath 111 to carry the substrate 131 to the drying bath 111 or the treating bath 141.

A lid 113 is disposed on the top of the drying bath 111, and a sliding door 119 is disposed on the bottom thereof. While the lid 113 is uncovered, the substrate 131 is putting into the drying bath 111. While the sliding door 119 is opened, the substrate 131 is transferred to the treating bath 141 from the drying bath 111 and vice versa. The gases in the drying bath 111 are exhausted to the outside through the sliding door 119 when valves 153 and 154 are opened.

A nozzle 112 is provided at the drying bath 111 to supply drying fluids, such as IPA and nitrogen (N₂), into the drying bath 111. The supply of the drying fluids is done by a downflow manner. The drying fluids may be organic solvents, which are soluble in water and serve to lower a surface tension of deionized water (DIW) on the substrate, such as IPA, alcohols, ketones (e.g., diethyl ketone), ethers (e.g., methyl ether or ethyl ether). The nitrogen may be replaced with inert gas such as helium or argon.

With gas-phase nitrogen, liquid-phase IPA is supplied to a vaporizer 114 to be vaporized. The vaporized IPA is heated by a heater 116 before being supplied to a nozzle 112. The nitrogen may be supplied to the vaporizer 114 while being heated. A valve 117 controls whether drying fluid (mixed fluid of IPA and N₂) is supplied to the nozzle 112. Impurities of the drying fluid are filtered through a filter 118 before the drying fluid is supplied to the nozzle 112.

The drying fluid may be solidified at the filter 118 before being supplied to the nozzle 112. In the case where the supply amount of the IPA increases (e.g., 400 ml/min or more), the IPA may be supplied to the nozzle 112 while not being fully vaporized. The non-fully-vaporized IPA may be solidified at the filter 112. If solidified IPA is supplied into the drying bath 111, it may attach to the substrate 131 to act as particles. A heater 120 is provided for heating the filter 118 to suppress the solidification of the IPA at the filter 118. As will be described below, the heater 120 is a so-called jacket heater configured to surround the filter 118. The heater 120 receives an electrical power to generate heat.

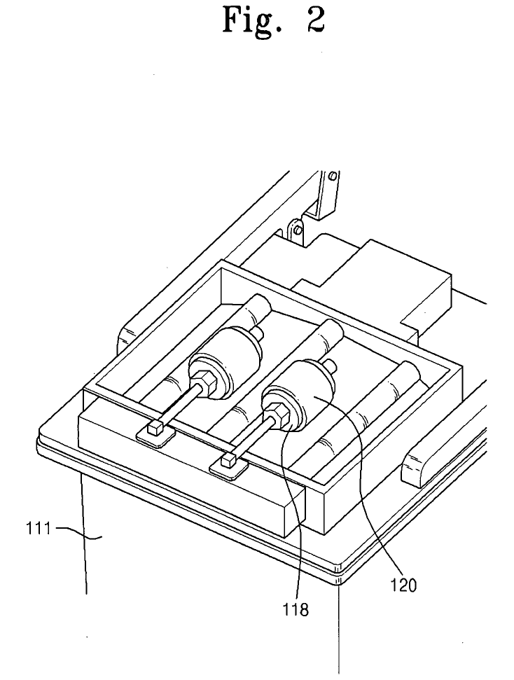

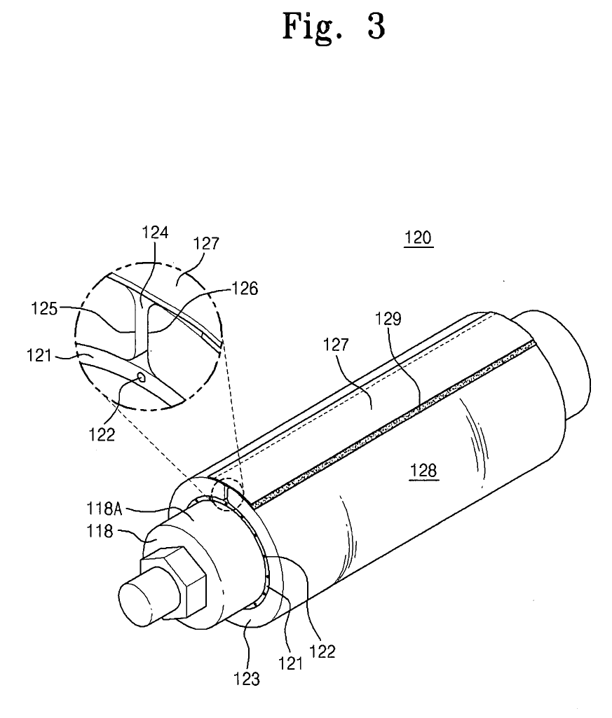

FIG. 2 is an enlarged perspective view of a part of the substrate treating apparatus 100 illustrated in FIG. 1, and FIG. 3 is a partial enlarged view of the heater 120 illustrated in FIG. 2.

Referring to FIGS. 2 and 3, the filter 120 may be a so-called jacket heater or heater jacket configured to surround the filter 118. The heater 120 includes a jacket 123 and a heater mat 121. The heater mat 121 is in contact with an external surface 118A of the filter 118. A heating wire 122 is provided to the heater mat 121. The heating wire 122 is made of a conductive material such as nickel or nickel chrome. An electrical power is applied to the heating wire 122 to generate heat. The heat generated by the heating wire 122 is directly transferred to the filter 118 by means of heat conduction. The jacket 123 stretches radially outwardly from the heater mat 121 and surrounds the heater mat 121. The jacket 123 is made of a flexible insulating material (e.g., silica fiber) having relatively low heat conductivity to enable the heat generated from the heater mat 121 to flow radially inwardly toward the filter 118. Due to the above structure, an efficiency of heat transfer to the filter 118 from the heater mat 121 is enhanced and the heat is insulated at a circumferential surface 128 to prevent heat loss.

The heater 120 includes a slit 124, which stretches in a length direction of the heater 120. On the surface 118A of the filter 118, edge surfaces 125 and 126 forming the slit 124 come in contact with each other or are separated from each other to attach or remove the heater 120. A flexible strap 127 is provided to the circumferential surface 128 of the heater 120 to couple the heater 120 with the filter 118. The strap 127 is fixed to a fastener 129 mounted on the circumferential surface 128 of the heater 120 to prevent the edge surfaces 125 and 126 stretching and the heater 120 separating from the filter 118. The fixture of the strap 127 to the fastener 129 may be done by means of an adhesive, Velcro or the like.

The operation of the foregoing substrate treating apparatus will now be described below in detail.

While a sliding door 119 is closed, a lid 113 is uncovered to open the top of a drying bath 111 and a substrate 131 is put into the drying bath 111 (S100). When the substrate 131 is put into the drying bath 111, the lid 113 is covered and the sliding door 119 is opened to descend the substrate 131 to the treating bath 141 (S110). The descent of the substrate 131 is done by descending a substrate support 130. When the substrate 131 is descended to the treating bath 141, the sliding door 119 is closed.

When the substrate 131 is put into the treating bath 141, a chemical is supplied to the treating bath 141 through a nozzle 144 to perform a chemical treatment (S120). Before the substrate 131 is put into the treating bath 141, the chemical may be supplied to the treating bath 141. After the chemical treatment is performed, the chemical is drained and deionized water (DIW) is supplied to the treating bath 141 through the nozzle 144 to clean the substrate 131 (S130). Alternatively, while the chemical used in the chemical treatment are not drained, the DIW may be supplied to the treating bath 141 and thus the chemical may be gradually diluted to clean the substrate 131. While the substrate 131 is treated using the chemical and the DIW in the treating bath 141, a drying fluid atmosphere may be established inside the drying bath 111 by supplying drying fluid (e.g., IPA or mixed gas of IPA and N₂) into the drying bath 111 (S140).

When the chemical treatment is ended, the sliding door 119 is opened to ascend the substrate 131 to the drying bath 111 (S150). While the substrate 131 is ascended, IPA or mixed gas of IPA and N₂ may be supplied into the drying bath 111. When the substrate 111 reaches the drying bath 111, the sliding door 119 is closed to seal the drying bath 111. At this point, the IPA or the mixed gas of IPA and N₂ supplied into the treating bath 141, fumes caused by a chemical or noxious gas may be exhausted by opening a valve 151 (S160).

The drying fluids, i.e., IPA and mixed gas of IPA and N₂ flow down into the drying bath 111 through a nozzle 112 to perform a first drying treatment for the substrate 131 (S170). After the first drying treatment is performed, N₂ gas flows down into the drying bath 111 to perform a second drying treatment for the substrate 131 (S190).

In the case where IPA and mixed gas of IPA and N₂ are supplied into the drying bath 111 to perform a first drying treatment, the IPA may be solidified at the filter 118 when the IPA and the mixed gas of IPA and N₂ pass the filter 118. Further, in the case where N₂ gas is supplied into the drying bath 111 to perform a second drying treatment, the IPA solidified at the filter 118 is supplied into the drying bath 111 with heated N₂. The solidified IPA supplied into the drying bath 111 attaches to the substrate 131 to act as particles. However, since the heater 120 configured to surround the filter 118 operates to heat the filter 118 (S180), the solidification of the IPA is suppressed at the filter 118. Moreover, since the filter 118 is heated by the heater 120, a small amount of water remaining at the filter 118 is removed. The heating of the filter 118 may be done at any time, e.g., before or after the first drying treatment, before the second drying treatment, or between the first and second drying treatments.

When the drying treatment is ended, valves 153 and 154 are opened to exhaust the IPA and the mixed gas of IPA and N₂ supplied into the drying bath 111 (S200). The lid 113 is uncovered to draw out the substrate 131 to the outside (S210).

As explained so far, a heater is provided to a filter installed at the front end of an injection nozzle configured to supply drying fluid to a drying bath to prevent the solidification of the drying fluid at the filter and remove a small amount of remaining water on the substrate. Thus, the generation of particles caused by supplying solidified drying fluid to a drying bath is suppressed to treat a substrate without error. As a result, a production or yield increases.

Although the present invention has been described in connection with the embodiment of the present invention illustrated in the accompanying drawings, it is not limited thereto. It will be apparent to those skilled in the art that various substitutions, modifications and changes may be made without departing from the scope and spirit of the invention.

What is claimed is:

1. A substrate treating apparatus, comprising:
a treating unit including a treating bath and a treating solution supply means for supplying a treating solution into the treating bath; and
a drying unit including a drying bath and a fluid supply means for supplying a fluid into the drying bath,
wherein the fluid supply means includes a filter configured to filter the fluid before the fluid is supplied into the drying bath and a first heater configured to heat the filter.

2. The substrate treating apparatus of claim 1, wherein the first heater includes a jacket heater configured to surround the filter.

3. The substrate treating apparatus of claim 2, wherein the jacket heater comprises:
a heater mat being in contact with a surface of the filter and including a heating wire; and
a jacket configured to surround the heater mat and made of a flexible insulating material.

4. The substrate treating apparatus of claim 1, further comprising:
a vaporizer configured to vaporize the fluid before the fluid is supplied to the filter; and
a second heater configured to heat the vaporized fluid.

5. A substrate treating apparatus comprising:
a treating bath;
a treating solution injection nozzle installed inside the treating bath and configured to inject a treating solution into the treating bath;
a drying bath disposed on the outside top of the treating bath and having open top and bottom, wherein a sliding door is provided between the open bottom and the treating bath, and a lid is provided to the open top;
a substrate support configured to support the substrate and transfer the substrate between the treating bath and the drying bath;
a gas injection nozzle disposed inside the drying bath and configured to inject gas used to dry the substrate into the drying bath;
a filter disposed outside the drying bath and configured to filter the gas; and
a heater jacket installed to surround the filter and configured to heat the filter.

6. The substrate treating apparatus of claim 5, wherein the gas includes a mixed gas of inert gas and organic solvent for primarily drying the substrate and an inert gas for secondarily drying the substrate.

7. The substrate treating apparatus of claim 5, wherein the treating solution includes a first treating solution for chemically treating the substrate and a second treating solution for rinsing the chemically treated substrate.

8. The substrate treating apparatus of claim 5, further comprising:
a recovery bath disposed outside the treating bath to recover the supplied treating solution overflowing from the treating bath; and
treating solution recovery means for re-supplying the recovered treating solution into the treating bath.

9. A substrate treating method comprising:
putting a substrate into a drying bath;
transferring the substrate to a treating bath from the drying bath;
supplying a treating solution into the treating bath to treat the substrate;
transferring the treated substrate to the drying bath;
supplying fluid into the drying bath to dry the substrate, wherein before supplying the fluid into the drying bath, the fluid is heated to prevent the solidification of the fluid; and
drawing out the dried substrate.

10. The substrate treating method of claim 9, wherein the supplying a treating solution into the treating bath to treat the substrate comprises:
supplying a chemical into the treating bath to chemically treat the substrate; and
supplying deionized water into the treating bath to clean the chemically treated substrate.

11. The substrate treating method of claim 9, further comprising when supplying a treating solution into the treating bath to treat the substrate:
supplying the fluid into the drying bath to make the drying bath an atmosphere of the fluid.

12. The substrate treating method of claim 9, wherein the supplying fluid into the drying bath to dry the substrate comprises:
supplying mixed gas of organic solvent and inert gas into the drying bath to dry the substrate; and
supplying inert gas into the drying bath to dry the substrate.

13. The substrate treating method of claim 9, wherein the supplying fluid into the drying bath to dry the substrate comprises:
supplying the fluid to a vaporizer, before supplying the fluid into the drying bath, to vaporize the fluid;
filtering the vaporized fluid through a filter; and
heating the filter to prevent the solidification of the vaporized fluid.

14. A substrate treating method comprising:
putting a substrate into a drying bath;
filtering first fluid through a filter and supplying the filtered first fluid into the drying bath to primarily dry the substrate;
filtering second fluid through a filter and supplying the filtered second fluid into the drying bath to secondarily dry the substrate; and
heating the filter to prevent at least one of the first and second fluids from being solidified at the filter.

15. The substrate treating method of claim 14, wherein the first fluid is mixed gas of organic solvent and inert gas, and the second fluid is inert gas.

16. The substrate treating method of claim 14, wherein the heating the filter is performed before or after primarily drying the substrate, or before secondarily drying the substrate, or between primarily drying the substrate and secondarily drying the substrate.
